(19) United States
(12) Patent Application Publication
(10) Pub. No.: US 2018/0282502 A1
(43) Pub. Date: Oct. 4, 2018

(54) AROMATIC LATEX AND ITS METHOD OF FABRICATING

(71) Applicant: Guobin Liu, Shenzhen (CN)

(72) Inventor: Guobin Liu, Shenzhen (CN)

(21) Appl. No.: 15/472,307

(22) Filed: Mar. 29, 2017

(51) Int. Cl. C08J 9/00

(52) U.S. Cl. CPC C08J 9/0014; C08J 9/0061; C08J 2407/02; C08J 9/0066; C08J 2309/08; C08J 9/0023

(57) ABSTRACT

A kind of aromatic latex and its fabricating method of mixing and foaming by the following components at the weight ratio of 10˜20 percent of natural latex, 70˜80 percent of synthetic latex, 0.5˜2 percent of aromatizer, 1˜3 percent of fatty acid ester, 4˜6 percent of sulphur, 1˜3 percent of zinc oxide, 0.5˜2 percent of curing agent. The present invention belongs to the technical field of latex material, particularly a kind of aromatic latex and its fabricating method with merits of high breathability, high elasticity, strong supporting force, aromatic and fresh smell that can improve the sleep quality with the efficacy of skin care and health care. This aromatic latex is mainly used for fabrication of latex mattress.

### FIELD OF THE INVENTION

The present invention belongs to the technical field of latex material, particularly a kind of aromatic latex and its fabricating method.

### BACKGROUND OF THE INVENTION

Sleep is essential to the health, besides the reasons of work, life, physical, psychology and others, the healthy bedding articles are the key points to the high quality sleep. With the development of material civilization and the technology, types of mattress and pillows for humans are tend to be diversified, especially the large market demand for the mattress mainly made from natural latex. The natural latex products can better improve the sleep quality if added some miscellaneous functions. Therefore a kind of natural aromatic latex material with fresh smell and its fabricating method is urgent to be researched.

### SUMMARY OF THE INVENTION

In order to solve the existing problem above-mentioned, the present invention provides a kind of aromatic latex and its fabricating method with merits of high breathability, high elasticity, strong supporting force, aromatic and fresh smell that can improve the sleep quality with the efficacy of skin care and health care. This aromatic latex is mainly used for fabrication of latex mattress.

The present invention adopts the following technical solutions: a kind of aromatic latex mixed and foamed by the following components at the weight ratio of 10˜20 percent of natural latex, 70˜80 percent of synthetic latex, 0.5˜2 percent of aromatizer, 1˜3 percent of fatty acid ester, 4˜6 percent of sulphur, 1˜3 percent of zinc oxide, 0.5˜2 percent of curing agent.

Further, a kind of aromatic latex mixed and foamed by the following components at the weight ratio of 15 percent of natural latex, 75 percent of synthetic latex, 1 percent of aromatizer, 2 percent of fatty acid ester, 4 percent of sulphur, 2 percent of zinc oxide, and 1 percent of curing agent.

Further, the molecular weight of the said natural latex is 2×10⁵˜3×10⁵ g/mol; the solid content of the said natural latex is no lower than 60%; the particle diameter of the said natural latex is 1˜2 μm.

Further, the said synthetic latex is styrene butadiene rubber. Styrene butadiene rubber (SBR) also named as polystyrene butadiene copolymer whose physical properties, processing properties and utility performances of the products are close to the natural latex while it also has some properties of wear resistance, heat resistance, ageing resistance and curing speed that better than natural latex.

Further, the said aromatizer is green tea powder or rose powder.

In addition, a fabricating method for aromatic latex comprising the following procedures:
1) Taking every component according to the weight ratio;
2) Mixing uniformly the natral latex, synthetic latex and aromatizer according to the ratio to get the Mixture 1 for standby application;
3) Adding the fatty acid ester according to the ratio into the Mixture 1 to control the pH value between 7˜7.5 to get the Mixture 2;
4) Adding the sulphur and zinc oxide according to the ratio into the Mixture 2 then mixing uniformly at the temperature of 35˜45° C. for reaction time of 40˜120 minutes to get the Mixture 3;
5) Pumping the Mixture 3 into foaming machine simultaneously adding curing agent according to the ratio for mechanical stirring foaming, then pouring the foamed mixture into the model or conveyer belt transported into steam box at the temperature of 110˜120° C. to get the transient aromatic latex material.
6) Dehydrating and drying the above transient aromatic latex material to get the finished aromatic latex product.

Adopting the above mentioned technical solution, the following beneficial effects of the invention is achieved: the aromatic latex of the present invention has the merits of high breathability, high elasticity and strong supporting force, with fresh fragrance of green tea or rose besides the natural smell of traditional latex materials; this aromatic latex is mainly used for fabrication of latex mattress whose fresh fragrance can regulate central nervous, improve the sleep quality and be absorbed by human body to have the efficacy of liver relief, blood circulation promotion, weight loss, health care, skin care, eyesight improvement and brain fitness to make people wholeheartedly comfortable and improve the sleep quality.

### DETAILED DESCRIPTION OF PREFERRED EMBODIMENTS

The technical solutions of the embodiments will be described clearly and completely. Obviously, the embodiments are just a part and not all of the implementations. Based on the implementations of the present invention, the other implementations obtained by those skilled in the art without creative work will all fall within the scope of the invention.

Embodiment 1, a kind of aromatic latex mixed and foamed by the following components at the weight ratio of 15 percent of natural latex, 75 percent of synthetic latex, 1 percent of aromatizer, 2 percent of fatty acid ester, 4 percent of sulphur, 2 percent of zinc oxide, and 1 percent of curing agent.

A fabricating method for the aromatic latex comprises the following procedures:
1) Taking every component according to the weight ratio;
2) Mixing uniformly the natral latex, synthetic latex and aromatizer according to the ratio to get the Mixture 1 for standby application;
3) Adding the fatty acid ester according to the ratio into the Mixture 1 to control the pH value between 7˜7.5 to get the Mixture 2;
4) Adding the sulphur and zinc oxide according to the ratio into the Mixture 2 then mixing uniformly at the temperature of 35˜45° C. for reaction time of 40˜120 minutes to get the Mixture 3;
5) Pumping the Mixture 3 into foaming machine simultaneously adding curing agent according to the ratio for mechanical stirring foaming, then pouring the foamed mixture into the model or conveyer belt transported into steam box at the temperature of 110˜120° C. to get the transient aromatic latex material.
6) Dehydrating and drying the above transient aromatic latex material to get the finished aromatic latex product.

Embodiment 2, a kind of aromatic latex mixed and foamed by the following components at the weight ratio of 12 percent of natural latex, 73 percent of synthetic latex, 2 percent of aromatizer, 3 percent of fatty acid ester, 5 percent of sulphur, 3 percent of zinc oxide, and 2 percent of curing agent.

A fabricating method for the aromatic latex comprises the following procedures:
1) Taking every component according to the weight ratio;
2) Mixing uniformly the natral latex, synthetic latex and aromatizer according to the ratio to get the Mixture 1 for standby application;
3) Adding the fatty acid ester according to the ratio into the Mixture 1 to control the pH value between 7˜7.5 to get the Mixture 2;
4) Adding the sulphur and zinc oxide according to the ratio into the Mixture 2 then mixing uniformly at the temperature of 35˜45° C. for reaction time of 40˜120 minutes to get the Mixture 3;
5) Pumping the Mixture 3 into foaming machine simultaneously adding curing agent according to the ratio for mechanical stirring foaming, then pouring the foamed mixture into the model or conveyer belt transported into steam box at the temperature of 110˜120° C. to get the transient aromatic latex material.
6) Dehydrating and drying the above transient aromatic latex material to get the finished aromatic latex product.

Embodiment 3, a kind of aromatic latex mixed and foamed by the following components at the weight ratio of 10 percent of natural latex, 77 percent of synthetic latex, 1.5 percent of aromatizer, 3 percent of fatty acid ester, 5 percent of sulphur, 2 percent of zinc oxide, and 1 percent of curing agent.

A fabricating method for the aromatic latex comprises the following procedures:
1) A fabricating method for the aromatic latex comprises the following procedures:
2) Mixing uniformly the natral latex, synthetic latex and aromatizer according to the ratio to get the Mixture 1 for standby application;
3) Adding the fatty acid ester according to the ratio into the Mixture 1 to control the pH value between 7˜7.5 to get the Mixture 2;
4) Adding the sulphur and zinc oxide according to the ratio into the Mixture 2 then mixing uniformly at the temperature of 35˜45° C. for reaction time of 40˜120 minutes to get the Mixture 3;
5) Pumping the Mixture 3 into foaming machine simultaneously adding curing agent according to the ratio for mechanical stirring foaming, then pouring the foamed mixture into the model or conveyer belt transported into steam box at the temperature of 110˜120° C. to get the transient aromatic latex material.
6) Dehydrating and drying the above transient aromatic latex material to get the finished aromatic latex product.

The aromatic latex of the present invention and its fabricating method has the merits of high breathability, high elasticity and strong supporting force for neck, head and body to reduce the burden on spine and to improve the sleep quality with the fragrant smell, which highly satisfies the customers.

The detailed description above is just the embodiments of the present invention and not to limit the patent scope of the invention. All the equivalent structures and process modifications based on the specification of the present invention as well as the applications directly or indirectly in the other relevant technical field should also fall within the scope of the invention.

1. A kind of aromatic latex mixed and foamed by the following components at the weight ratio of 10˜20 percent of natural latex, 70˜80 percent of synthetic latex, 0.5˜2 percent of aromatizer, 1˜3 percent of fatty acid ester, 4˜6 percent of sulphur, 1˜3 percent of zinc oxide, and 0.5˜2 percent of curing agent.

2. The aromatic latex of claim 1, which is mixed and foamed by the following components at the weight ratio of 15 percent of natural latex, 75 percent of synthetic latex, 1 percent of aromatizer, 2 percent of fatty acid ester, 4 percent of sulphur, 2 percent of zinc oxide, and 1 percent of curing agent.

3. The aromatic latex of claim 1, wherein the molecular weight of the said natural latex is 2×10⁵˜3×10⁵ g/mol; the solid content of the said natural latex is no lower than 60%; the particle diameter of the said natural latex is 1˜2 μm.

4. The aromatic latex of claim 1, wherein the said synthetic latex is styrene butadiene rubber.

5. The aromatic latex of claim 1, wherein the said aromatizer is green tea powder or rose powder.

6. A fabricating method for aromatic latex comprising the following procedures:
1) Taking every component according to the weight ratio;
2) Mixing uniformly the natral latex, synthetic latex and aromatizer according to the ratio to get the Mixture 1 for standby application;
3) Adding the fatty acid ester according to the ratio into the Mixture 1 to control the pH value between 7˜7.5 to get the Mixture 2;
4) Adding the sulphur and zinc oxide according to the ratio into the Mixture 2 then mixing uniformly at the temperature of 35˜45° C. for reaction time of 40˜120 minutes to get the Mixture 3;
5) Pumping the Mixture 3 into foaming machine simultaneously adding curing agent according to the ratio for mechanical stirring foaming, then pouring the foamed mixture into the model or conveyer belt transported into steam box at the temperature of 110˜120° C. to get the transient aromatic latex material.
6) Dehydrating and drying the above transient aromatic latex material to get the finished aromatic latex product.
